(19) United States
(12) Patent Application Publication
(10) Pub. No.: US 2020/0394016 A1
(43) Pub. Date: Dec. 17, 2020

(54) IMAGE-AUGMENTED AUTOMATED ASSISTANT

(71) Applicant: International Business Machines Corporation, Armonk, NY (US)

(72) Inventors: Craig M. Trim, Ventura, CA (US); Michael Bender, Rye Brook, NY (US); Sarbajit K. Rakshit, Kolkata (IN); Martin G. Keen, Cary, NC (US)

(21) Appl. No.: 16/438,668

(22) Filed: Jun. 12, 2019

(51) Int. Cl. G06F 3/16; G06F 17/27; G06F 9/54; G10L 15/26

(52) U.S. Cl. CPC G06F 3/167; G06F 17/2705; G10L 15/26; G06F 9/542; G06F 17/2765

(57) ABSTRACT

A prompt is received from a user. The prompt includes a plurality of words. A request of the prompt is determined using natural language processing techniques on the plurality of words. One or more images from the user are received. Additional data related to the prompt is identified from the one or more images. A response to the request is provided to the user. The response is determined, in part, with the additional data.

### BACKGROUND

Automated assistants are getting very popular. While using automated assistants, users can ask textual and verbal questions, in response to which the automated assistants may use speech-to-text and natural language processing (NLP) techniques and the like to understand and then reply to the user. In this way, automated assistants may perform such functions as home automation, computing system management, or answering questions as a version of a search engine for a user.

### SUMMARY

Aspects of the present disclosure relate to a method, system, and computer program product relating to augmenting the capabilities of an automated assistant with one or more images. For example, the method includes receiving, by a processor, a prompt from a user that includes a plurality of words. The method also includes determining, by the processor using natural language processing (NLP) techniques on the plurality of words, a request of the prompt. The method also includes receiving, by the processor, one or more images from the user. The method also includes identifying, by the processor and from the one or more images, additional data related to the textual prompt. The method also includes providing, by the processor and to the user, a response to the textual prompt that was determined in part with the additional data.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a conceptual diagram of an example system in which a controller manages an automated assistant that is using a corpus to assist a user using images from one or more cameras.

FIG. 2 depicts an example situation in which a controller may use images from a camera to augment the abilities of an automated assistant in assisting a user with a furnace.

FIG. 3 depicts an example conceptual box diagram of a computing system that may be configured to augment an automated assistant with images.

FIG. 4 depicts an example flowchart of augmenting an automated assistant with images.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to automated assistants, and more particular aspects relate to augmenting the capabilities of automated assistants with images. While the present disclosure is not necessarily limited to such applications, various aspects of the disclosure may be appreciated through a discussion of various examples using this context.

Users may use automated assistants to learn more about a subject and/or to assist with home automation activities or the like. For example, a user may ask an automated assistant what the weather is, where the nearest bakery is, or other similar questions to learn about a subject (e.g., such that the automated assistant functions as a type of search engine). Alternatively, or additionally, a user may ask an automated assistant to turn off a television or to arm a security system or the like. Users may interact with the automated assistant via one or more interfaces of one or more devices. For example, users may interact with the automated assistant via voice commands spoken to a cell phone or laptop or home automation device. Additionally, or alternatively, users may interact with the automated assistant via one or more graphical interfaces, by, e.g., typing a question into an entry field of an automated assistant software application hosted on a computing device. Other examples are also possible.

In some examples, a user may experience difficulty in trying to communicate a desired request to the automated assistant. For example, a user may have a question regarding something that the user is looking at but cannot identify, such that the user struggles to put into words a question that the automated assistant may understand. To list an example of this, a user may be looking to rent an impact wrench, but may not know or may not remember that the tool that he wants to rent is called an impact wrench. In such an example, it may be difficult and/or frustrating for the user to articulate the question in a format which the automated assistant can understand the meaning of the question and respond appropriately. This may be particularly true for an audible request as a result of potential stress of speaking to an automated assistant, as questions to an automated assistant may be relatively more likely to be answered if the question is asked clearly without substantial pauses, such that it may be necessary or advantageous to have a fully defined question before the user begins talking to the automated assistant. As such, where the user is interacting with the automated assistant about a situation that includes one or more visual elements that are not fully known or understood by the user, it may be difficult or impossible for the user to request help from the automated assistant about these elements.

Aspects of this disclosure may address or solve this difficulty. For example, aspects of this disclosure relate to receiving image input from one or more cameras and using image recognition techniques to identify a component of a physical item, and/or identifying how a user is interacting with a physical item, or the like. The image input may include information that a user was unable to or was otherwise having difficulty expressing to an automated assistant. A computing controller may request or directly gather the image input in response to identifying that the user is having difficulty expressing a request. In some examples, the controller may further direct the user in gathering particular images that may be useful to the controller. In other examples, the controller may autonomously gather one or a series of images to gather additional information. In either example, the controller may gain an affirmative allowance from user (e.g., an expressed opt-in from the user as entered on a mobile phone or the like) prior to the controller receiving, gathering, or analyzing images related to the user.

Once received, the controller may use image recognition techniques to identify the additional information contained within the image input. The controller may use the information gained from the image(s) to supplement the verbal and/or textual information provided by the user. Once supplemented, the controller may determine and provide a response to the prompt of the user. The controller may compare both the verbal/textual information from the user as well as the visual data from the input image against a corpus of data that includes verbal data, textual data, and image data to determine the response. Using both the directly provided verbal/textual information and the additional information identified from the input images, the automated assistant may have an increased ability to quickly and accurately respond to the request of the user. Put differently, the controller may enable an automated assistant to respond to queries that the user is having difficulties articulating.

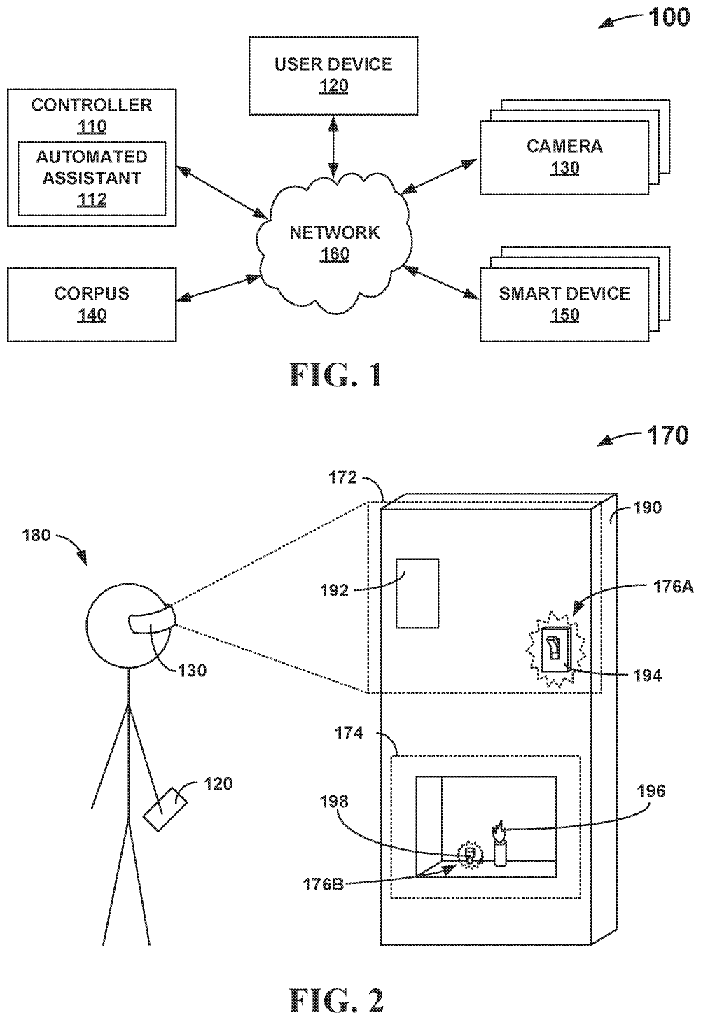

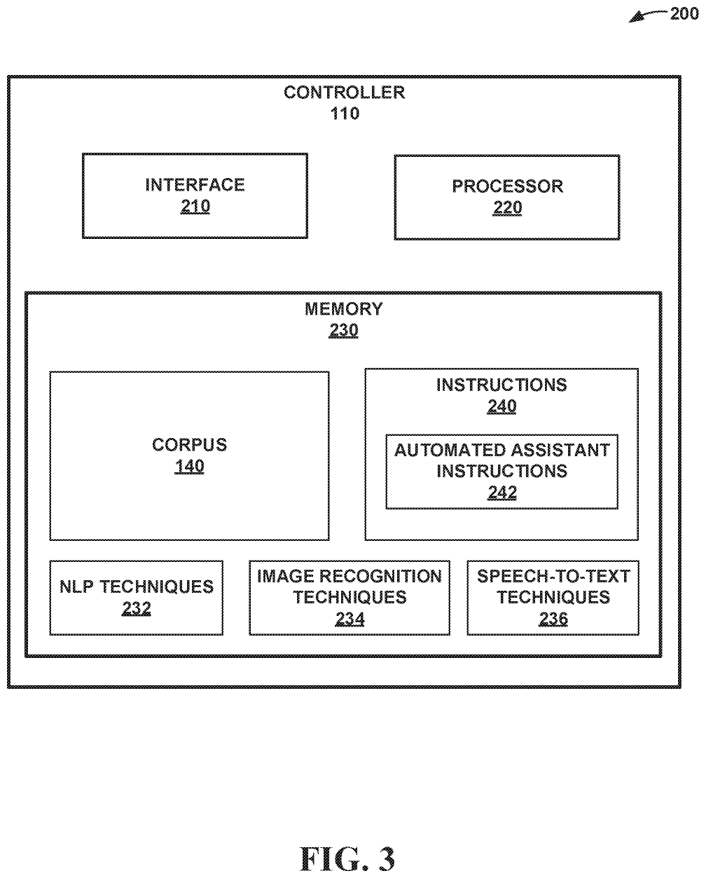

For example, FIG. 1 depicts system 100 that includes controller 110 that is configured to augment automated assistant 112 using one or more images, in accordance with embodiments of the present disclosure. Controller 110 may include a computing device, such as computing device 200 of FIG. 3 that includes processor 220 communicatively coupled to memory 230 that includes instructions 240 that, when executed by processor 220, cause controller 110 to execute the operations described below. As depicted in FIG. 1, controller 110 may include automated assistant 112. Automated assistant 112 may be configured to answer questions (e.g., as part of a question/answer system) and/or execute operations (e.g., as part of a building automation system) as requested by a user. For example, automated assistant 112 may use natural language processing (NLP) techniques as described herein to determine a meaning of a question or prompt or command. Once a meaning is determined, automated assistant 112 may use corpus 140 to determine an answer or responding action to the question or prompt or command of the user.

Corpus 140 may include a massive collection of data (e.g., thousands, hundreds of thousands, or millions of questions and associated answers and documents related to the questions and answers). Corpus 140 may include data that is tagged (or otherwise associated) with metadata that structures the data within corpus 140. For example, data of corpus 140 may be structured such that the data is organized by where the data came from (e.g., whether it was a question or whether it was determined to be an answer), how the data was handled (e.g., whether it is a question that was answered, and if so if the user accepted the answer), or the like. In some examples, corpus 140 may include data that was previously unstructured (e.g., verbal questions that were initially received as an audio file) before being structured (e.g., tagged with metadata indicating words of the audio file, a meaning of the audio file, or the like). Corpus 140 may be stored on a computing device (e.g., such as computing device 200 of FIG. 3) such as a server or a rack of servers or the like.

Automated assistant 112 may access corpus 140 over network 160. Network 160 may include a computing network over which computing messages may be sent and/or received. For example, network 160 may include the Internet, a local area network (LAN), a wide area network (WAN), a wireless network, or the like. Network 160 may comprise copper transmission cables, optical transmission fibers, wireless transmission, routers, firewalls, switches, gateway computers, and/or edge servers. A network adapter card or network interface in each computing/processing device (e.g., controller 110, user devices 120, cameras 130, corpus 140, and/or smart devices 150) may receive messages and/or instructions from and/or through network 160 and forwards the messages and/or instructions for storage or execution or the like to a respective memory or processor of the respective computing/processing device.

Though network 160 is depicted as a single entity in FIG. 1 for purposes of illustration, in other examples network 160 may include a plurality of private or public networks. For example, user device 120, cameras 130, and/or smart devices 150 (e.g., a WLAN-enabled television, lightbulb, kitchen appliance, furnace, thermostat, security system, or the like) may communicate together over a private WLAN of network 160. Further, controller 110/automated assistant 112 and corpus 140 may communicate together over a private LAN of network 160. Additionally, controller 110 and/or automated assistant 112 may communicate with user device 120, cameras 130, and/or smart devices 150 over network 160 using the Internet.

In some examples, as discussed above, automated assistant 112 may be configured to automate functionality of a home. For example, automated assistant 112 may have access to one or more smart devices 150. Smart devices 150 may include appliances and features of a home such as a television, a garage door, a furnace, an air conditioner, lights, speakers, security systems, or the like. Using such access, automated assistant 112 may turn on, turn off, or otherwise modulate states or outputs of the smart devices 150 (e.g., by changing a channel of a television, turning down lights or speakers, changing a temperature outlet of a furnace or an air conditioner, or the like). Automated assistant 112 may execute this functionality in addition to, or as an alternate of, question-answering functionality as described above.

As depicted in FIG. 1, automated assistant 112 may be integrated into controller 110, such that both controller 110 and automated assistant 112 may be part of a single computing system 200. In other examples (not depicted), automated assistant 112 as described may be hosted on a separate computing device (one similar to computing device 200 of FIG. 3). In certain examples, each of automated assistant 112, controller 110, and corpus 140 may be integrated into a single computing device (e.g., similar to what is depicted and discussed below with relation to FIG. 3). Further, though automated assistant 112 is described herein as a component within controller 110 (wherein controller 110 is itself configured to gather and/or receive images to augment abilities of automated assistant 112), in other examples controller 110 may be a sub-component within (e.g., a software module of) automated assistant 112 that is configured to answer questions of and automate device functionality for a user.

As described above, automated assistant 112 may receive questions and automation queries or the like over network 160 from one or more user devices 120. User device 120 may include a computing device (similar to computing device 200 of FIG. 3 as described below) such as a laptop, a desktop computer, mobile phone, smart wearable device (e.g., smart watches or smart glasses), augmented reality (AR) device such as AR glasses, or the like. User devices 120 may include a processor communicatively coupled to a memory, as described herein. User device 120 may send requests or queries to automated assistant 112 over network 160. Requests or queries may take the form of verbal questions or typed questions or the like. Automated assistant 112 may likewise provide responses over network 160 to the user via text generated on user device 120 or audible speech generated by user device 120 or the like. Additionally, or alternatively, automated assistant 112 may respond to user questions or commands by modulating functions or states of one or more smart devices 150 over network 160.

Controller 110 may monitor communication between user devices 120 and automated assistant 112. Controller 110 may monitor communication for an indication that a user may be experiencing difficulty or frustration articulating a request to automated assistant 112. For example, controller 110 may identify one or more messages coming from user device 120 that relate to a single topic, none of which automated assistant 112 is able to answer. For example, controller 110 may detect a first query, “why is my fridge broken,” a second query, “how do I fix my fridge,” and a third query, “how do I find out what is wrong with my fridge,” each of which automated assistant 112 replies to with, “I'm sorry, I don't know how to help with that yet.” In this example, controller 110 may detect that a user is having difficulty as the user is inquiring about a single subject more than a threshold number of times (e.g., more than two times). In other examples, controller 110 may detect that a user is having difficulty after automated assistant 112 fails to provide a substantive response to a first inquiry (e.g., after the first time that automated assistant 112 replies with “I'm sorry, I don't know how to help with that yet.”).

Alternatively, controller 110 may detect automated assistant 112 providing a follow-up question to the user which the user does not answer. For example, a user may use user device 120 to send in a request, “how do I assemble this bookshelf,” in response to which automated assistant 112 sends a reply, “what step are you at in the assembly process,” after which the user does not send a response. Controller 110 may detect that automated assistant 112 did not receive a response to its follow-up inquiry, and may identify this as user difficulty.

Additionally, or alternatively, controller 110 may identify one or more elements of stress in the user's request to identify user difficulty. For example, controller 110 may identify that a second request or command is said louder, or with increased intensity, or with harsh language, and therein identify one or all of these as an indication that the user is having difficulty. Other examples of user difficulty are also possible.

Once controller 110 detects this difficulty, controller 110 may execute one or more operations in order to gain one or more images from one or more cameras 130. For example, controller 110 may cause automated assistant 112 to request the user to activate or wear a virtual reality or augmented reality device that includes camera 130 so that controller 110 and/or automated assistant 112 may better help the user. For another example, controller 110 may directly ask the user to provide controller 110 access to a video feed from one or more cameras 130 (e.g., a security camera) that is near user device 120.

Controller 110 may receive or otherwise gather images from one or more cameras 130. Images may include photographs and/or a video feed. Controller 110 may use image recognition techniques (e.g., such as image recognition techniques 234 as discussed in greater detail below) to identify additional data related to the inquiry from the user. Using this additional data, controller 110 may enable automated assistant 112 to answer the inquiry from the user. In some examples, a loop may be created between user device 120, cameras 130, and/or controller 110 and automated assistant 112. For example, the loop may include additional information being sent from cameras 130 to provide additional data to controller 110 and/or automated assistant 112, which therein formulate updates and/or answers for the user, potentially requesting that different/additional images are sent to provide different image data to controller 110 and/or automated assistant 112 to gain further updates and/or answers, etc., until the situation is resolved.

For example, to continue the fridge example from above, controller 110 may receive an image from camera 130 that controller 110 may use to identify a model number of the fridge. Controller 110 may then compare this model number against corpus 140 to identify a graphical user interface of the fridge with which controller 110 and/or automated assistant 112 may gather sufficient information to identify a problem with the fridge. Controller 110 and/or automated assistant 112 may thus direct the user pull up the graphical interface and therein pull up these identified sub-menus to identify the problem with the fridge.

For another example, to continue the bookshelf example from above, controller 110 may receive an image of the bookshelf in a state of assembly. Controller 110 may compare this image against corpus 140 to identify a make and model of the bookshelf, and using this make and model further pull up assembly instructions for this bookshelf within corpus 140. Comparing these instructions against the received image, controller 110 may identify that a user has moved from step #5 to step #7, and as such controller 110 and/or automated assistant 112 may direct the user to complete step #6 (and/or walk the user through the rest of the assembly).

Once controller 110 uses the received images to augment the capabilities of automated assistant 112 as described herein, controller 110 may add the executed steps to corpus 140 for future reference. Further, controller 110 may receive feedback from user device 120 as to whether or not the provided answer or automation or the like addressed the need and/or desire of the user. For example, controller 110 may expressly ask whether or not that answered the question, and identify the reply. For another example, controller 110 may identify whether or not the user follows the suggested action of automated assistant 112 and/or controller 110, where possible. Controller 110 may be more or less likely to execute steps in the future in a similar manner as a result of positive or negative feedback from the user, respectively. In this way, controller 110 may functionally learn how to improve at the process of using images to augment the ability of automated assistant 112 over time.

For example, FIG. 2 depicts a conceptual depiction of a situation 170 in which user 180 is trying to fix furnace 190. FIG. 2 is discussed with controller 110 executing operations of fixing furnace 190 for the sake of clarity, though it is to be understood that in other examples controller 110 may augment (e.g., by causing the request of, and therein analyzing and providing the identified information from, one or more images) automated assistant 112 as automated assistant 112 executes operations to assist user 180 fixing furnace 190. As depicted, user 180 may be holding user device 120 which is depicted as a mobile phone. Further, in FIG. 2 user 180 is wearing camera 130 which is depicted as an augmented reality (AR) device. Controller 110 may detect user 180 having difficulty asking automated assistant 112 about fixing furnace 190. For example, user 180 may be asking automated assistant 112 why furnace 190 is not staying on, and controller 110 may detect difficulty in the form of a repeated question.

In response to this, controller 110 may ask user 180 to put on (e.g., to wear) AR device camera 130. Controller 110 may request that user 180 put on AR device camera 130 in part because of an ability for controller 110 to create visual effects 176A-176B (collectively, “visual effects 176”) to better communicate with user 180. Visual effects 176 may include graphically shading or encircling or the like within the display viewed by user 180 that controller 110 creates as an augmented reality graphical effect using AR camera 130, such that user 180 may see the visual effects 176 as controller 110 speaks (e.g., speaks using user device 120) to user 180.

Controller 110 may analyze image 172 received from AR device camera 130 to detect label 192 of furnace 190. Using label 192, controller 110 may consult corpus 140 to identify a make and model of furnace 190. Using this make and model, controller 110 may pull up schematics of furnace 190 from corpus 140. Alternatively, controller 110 may pull up a generic schematic of furnace 190 from corpus 140, without identifying a make and model of furnace 190.

Controller 110 may identify power switch 194 on furnace 190 and instruct user 180 to turn furnace 190 off, wait a few seconds, and then turn furnace 190 back on, and therein inform controller 110 if that fixed furnace 190. In some examples, controller 110 may cause AR device camera 130 to create visual effect 176A as controller 110 communicate this to user 180 to assist in the instruction. For example, controller 110 may cause AR device camera 130 to create visual effect 176A around power switch 194 of furnace 190. Visual effect 176A may be a shape that visually encloses power switch 194. In some examples, visual effect 176A may include a relatively vibrant color to direct user 180 toward power switch 194. For example, visual effect 176A may include a neon color.

Controller 110 may detect a message from user 180 that furnace 190 turned on and output air, but did not output heat. In response to this, controller 110 may request that user 180 tilt AR device camera 130 down to receive image 174. Though image 172 and image 174 are both depicted as static and still images, it is to be understood that images as received by AR device camera 130 may be part of a video feed that includes a great plurality of images or a pseudo-constant feed of images. Controller 110 may request that user 180 turns furnace 190 on and off again using power switch 194 while AR device camera 130 is capturing image 174. Doing so, controller 110 may identify that pilot light 196 turns off after a few seconds of furnace 190 turning on. For example, controller 110 may receive a plurality of images 174 over time, and by comparing all of images 174 against a timestamp of each of images 174 controller 110 may identify that pilot light 196 ceases to exist within images 174 after a few seconds.

Controller 110 may submit a request (e.g., a verbal request using user device 120, or a verbal request to AR device where AR device has a speaker, or a written request that is graphically created in AR, or the like) to user 180 that user 180 pull out and clean pilot tube 198. Controller 110 may further generation specific instructions on how to clean pilot tube 198, and/or controller 110 may direct user 180 to a website that includes instructions on cleaning pilot tube 198. Controller 110 may create a visual effect 176B around pilot tube 198. In some examples, controller 110 may create a dynamically moving visual effect 176B, such as a counterclockwise arrow around a top bolt of pilot tube 198 indicating that pilot tube 198 can be unscrewed to remove pilot tube 198. In other examples, controller 110 may simply highlight or encircle pilot tube 198 within image 174 captured by AR device camera 130.

User 180 may inform controller 110 that removing and cleaning pilot tube 198 enabled pilot light 196 to stay on, therein fixing furnace 190. In some examples, controller 110 may continue gathering image 174 (and/or image 172) as a result of user 180 opting-in for ongoing inspection, such that controller 110 itself detects that cleaning pilot tube 198 enabled pilot light 196 to stay on. Additionally, and/or alternatively, controller 110 may monitor an output of furnace 190 with one or more smart devices 150 (such as a smart thermostat), such that controller 110 may be able to detect a temperature rising (e.g., indicating that furnace 190 is working). Controller 110 may save details and/or metrics of this interaction with user 180 in corpus 140, including details that indicate that controller 110 was able to help user 180 fix furnace 190, such that these actions of controller 110 are reinforced over time.

For example, in another instance controller 110 may have caused AR device to simply highlight a top bolt of pilot tube 198, after which it took user 180 two minutes to remove pilot tube 198. Conversely, as described above in this instance controller 110 may have caused AR device to create the counterclockwise arrow after which user 180 removed pilot tube 198 in 15 seconds. Being as the underlying metrics (e.g., the time for user 180 to act) for the counterclockwise arrow are better than for the simple highlight, controller 110 may reinforce the counterclockwise arrow generation behavior.

As described above, controller 110 may be included in computing device 200 with a processor configured to execute instructions stored on a memory to execute the techniques described herein. For example, FIG. 3 is a conceptual box diagram of such computing device 200 of controller 110. While controller 110 is depicted as a single entity (e.g., within a single housing) for the purposes of illustration, in other example controller 110 may include two or more discrete physical systems (e.g., within two or more discrete housings). Controller 110 may include interface 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and/or components within controller 110 (e.g., such as processor 220) to communicate with entities external to controller 110. Specifically, interface 210 may be configured to enable components of controller 110 to communicate with user devices 120, camera 130, corpus 140, smart devices 150, or the like. Interface 210 may include one or more network interface cards, such as Ethernet cards, and/or any other types of interface devices that can send and receive information. Any suitable number of interfaces may be used to perform the described functions according to particular needs.

As discussed herein, controller 110 may be configured to analyze images to augment an automated assistant such as described above. Controller 110 may utilize processor 220 to augment automated assistant with visual data. Processor 220 may include, for example, microprocessors, digital signal processors (DSPs), application specific integrated circuits (ASICs), field-programmable gate arrays (FPGAs), and/or equivalent discrete or integrated logic circuit. Two or more of processor 220 may be configured to work together to augment automated assistant with visual data.

Processor 220 may augment capabilities of an automated assistant with visual data according to instructions 240 stored on memory 230 of controller 110. As depicted, instructions 240 may include automated assistant instructions 242, such that controller 110 includes automated assistant 112 as depicted in FIG. 1. In other examples, as discussed above, instructions 240 for augmenting automated assistant 112 with images may instead be a sub-component of automated assistant instructions 242, and/or automated assistant instructions 242 and instructions 240 may be on separate computing devices working together.

Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may augment an automated assistant with visual data according to instructions 240 of one or more applications (e.g., software applications) stored in memory 230 of controller 110.

In addition to instructions 240 in some examples, gathered or predetermined data or techniques or the like as used by processor 220 to augment automated assistant with visual data may be stored within memory 230. For example, memory 230 may include information described above that may be stored in corpus 140, and/or may include substantially all of corpus 140 as depicted in FIG. 3.

For another example, memory 230 may include NLP techniques 232, image recognition techniques 234, and/or speech-to-text techniques 236 that processor 220 may execute according to instructions 240 when augmenting an automated assistant with visual data. For example, NLP techniques 232 can include, but are not limited to, semantic similarity, syntactic analysis, and ontological matching. For example, in some embodiments, processor 220 may be configured to parse messages from user and/or graphical messages from one or more images to determine semantic features (e.g., word meanings, repeated words, keywords, etc.) and/or syntactic features (e.g., word structure, location of semantic features in headings, title, etc.). Ontological matching could be used to map semantic and/or syntactic features to a particular concept. The concept can then be used to determine the subject matter. In this way, using NLP techniques 232, controller 110 may, e.g., identify two or more requests from a user to automated assistant as being related (such that the user is having difficulty using automated assistant).

Similarly, image recognition techniques 234 may include optical character recognition (OCR) for identifying text within received images, or general shape identification and/or recognition techniques, or object tracking techniques where images are received as a stream of images (e.g., as part of a video feed). Further, speech-to-text techniques 236 may be used to identify the text of speech said by the user in order to communicate with user and/or to identify when the user is having difficulty communication with automated assistant 112.

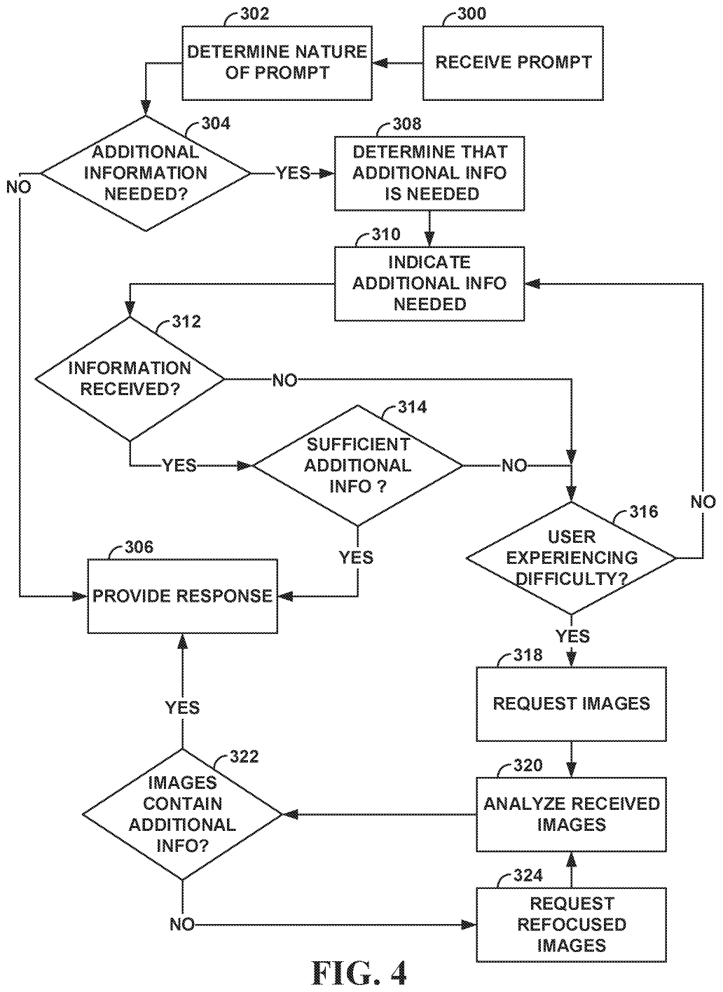

Using these components, controller 110 may augment capabilities of an automated assistant with images as discussed herein. For example, controller 110 may augment automated assistant with visual data according to the flowchart depicted in FIG. 4. The flowchart of FIG. 4 is discussed with relation to FIG. 1 for purposes of illustration, though it is to be understood that other systems may be used to execute the flowchart of FIG. 4 in other examples. Further, in some examples, system 100 may execute a different method than the flowchart of FIG. 4, or system 100 may execute a similar method with more or less steps in a different order, or the like.

A prompt is received (300). The prompt may be from user device 120 as sent to automated assistant 112. Controller 110 may detect this prompt. Automated assistant 112 and/or controller 110 may determine a nature of the prompt (302). For example, the prompt may be to answer a question of a user that the user sent via user device 120. Additionally, or alternatively, the prompt may relate to modulating the functionality or state of one or more smart devices 150 associated with the user.

It may be determined whether or not additional information is needed (304). Automated assistant 112 may make this determination. Automated assistant 112 may determine that additional information is needed based on whether automated assistant is able to reply to the prompt as understood by automated assistant 112. For example, if automated assistant 112 determines that automated assistant 112 is able to answer the question of the prompt or modulate the functionality of smart device 150 of the prompt, automated assistant 112 may identify that additional information is not needed. In response to identifying that additional information is not needed, automated assistant 112 may provide the response to the prompt (306).

Alternatively, if automated assistant 112 determines that it is not able to answer the question or change the state of the identified smart device 150, automated assistant 112 may determine the additional information that is needed (308). For example, automated assistant 112 may determine if a name, a model number, or the like is necessary in order for automated assistant 112 to answer the question or otherwise respond to the prompt.

Automated assistant 112 may indicate that additional information is needed (310). For example, automated assistant 112 may communicate using user device 120 what specific additional information is needed. Alternatively, automated assistant 112 may indicate that automated assistant 112 is not able to provide a response to that prompt. Controller 110 may determine if the additional information is received (312). The additional data may be received from user as sent via user device 120. If additional data is received, controller 110 and/or automated assistant 112 may identify if the received information is sufficient to respond to the initial prompt (314). If the additional information is sufficient, automated assistant 112 may determine a response using the additional information and provide this response (306).

Alternatively, if controller 110 determines that the additional data is not sufficient, and/or if controller 110 determines that additional data is not received, controller 110 may determine whether the user is experiencing difficulty (316). For example, controller 110 may determine that the additional data is not sufficient as a result of automated assistant 112 providing the same ineffective response as automated assistant 112 had provided previously (e.g., provided at 310). For another example, controller 110 may determine that no additional information is received if controller 110 identifies that user device 120 has not sent follow-up information to automated assistant 112 over network 160 for at least a threshold period of time (e.g., 90 seconds).

Controller 110 may determine that the user is having difficulty by evaluating one or more factors. For example, controller 110 may determine that the user is having difficulty based on a number of times that the user has provided this prompt and/or provided additional information. For another example, controller 110 may determine that the user is having difficulty based on an evaluation of one or more prompts received from user (e.g., by evaluating stress levels of an auditory prompt received over user device 120). In some examples, controller 110 may identify that a user is having difficulty as soon as a user is not able to provide sufficient information. If controller 110 identifies that a user is not having difficulty, controller 110 and/or automated assistant 112 may again indicate that additional information is needed (310).

If controller 110 identifies that the user is having difficulty, controller 110 may request images (316). Controller 110 may request images of an environment of user. Controller 110 may request images in response to controller 110 determining that the prompt of the user relates to a physical object. For example, controller 110 may determine that the prompt of the user relates to a physical object if the prompt relates to one or more smart devices 150, and/or if the user sends a prompt that mentions “this” object or “that” object, or the like.

Conversely, controller 110 may identify that it may not be useful to request images when the nature of the prompt is relatively theoretical or metaphysical or otherwise not relating to anything within an immediate vicinity of the user. For example, controller 110 may determine that an ability for automated assistant 112 to respond to the user may be minimally augmented with images for a prompt such as “how do I get to that new Italian restaurant across town,” or “what is the meaning of life,” or “what was my homework assignment.” In examples where controller 110 identifies that images may be less useful or not useful in this manner, controller 110 may determine not to request images.

Otherwise, as discussed herein, controller 110 may request images from one or more cameras 130. For example, controller 110 may request for access to one or more security cameras. Alternatively, or additionally, controller 110 may request for the user to put on some AR goggles that include a camera 130, as discussed herein. Alternatively, or additionally, controller 110 may request that the user may take a picture of the environment (e.g., using a camera of user device 120) and then send this picture to controller 110.

Controller 110 may analyze the received images (320). Controller 110 may use image recognition techniques to identify text characters and shapes and features of the received images. Controller 110 may analyze the received images to determine whether or not the received images contain the additional information needed to respond to the prompt (322). Where the received images do contain the additional information, controller 110 may provide the additional information to automated assistant 112, which may provide the response to the user (306).

If controller 110 determines that the received images do not include the additional information, controller 110 may analyze the image to identify a subsequent image that may include the additional information. For example, controller 110 may determine that a zoomed-in picture may include the additional information. For another example, controller 110 may determine that a picture taken using a camera flash may include the additional information. For another example, controller 110 may determine that an image that is slightly panned in a different direction from the previously received image(s) may contain the additional information.

Controller 110 may request that the user send additional images that are thusly refocused (324). For example, controller 110 may request that the user sends one or more additional images that are zoomed-in, or taken with the flash, or that are slightly moved down/over/up, or the like. Once received, controller 110 may analyze the received images (320) and therein determine if the received images include the additional information (322). If the additional images include the additional information, controller 110 may cause automated assistant 112 to provide the response (306) as described above. If not, controller 110 may continue requesting refocused images (324) as described herein until the additional information is gained.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
receiving, by a processor, a prompt from a user that includes a plurality of words;
determining, by the processor using natural language processing (NLP) techniques on the plurality of words, a request of the prompt;
receiving, by the processor, one or more images from the user;
identifying, by the processor and from the one or more images, additional data related to the prompt; and
providing, by the processor and to the user, a response to the request, the response determined in part with the additional data.

2. The method of claim 1, further comprising determining, by the processor, that the additional data is needed to provide the response to the prompt.

3. The method of claim 2, further comprising providing, by the processor and in response to determining that the additional data is needed, a request to the user to provide the one or more images.

4. The method of claim 3, further comprising the processor determining that the user is having difficulty providing the additional data via the prompt, wherein providing the request is further in response to determining that the user is having the difficulty.

5. The method of claim 1, wherein the prompt is an auditory prompt and the processor uses speech-to-text techniques to determine text of the auditory prompt containing the plurality of words.

6. The method of claim 1, wherein the one or more images include a video stream of images of a camera utilized by the user.

7. The method of claim 6, wherein the camera is integrated into an augmented reality wearable device of the user.

8. The method of claim 1, wherein receiving the one or more images further comprises:
determining, by the processor, that a first image of the one or more images does not include the additional data;
providing, by the processor and in response to determining that the first image does not include the additional data, a focusing request to the user to provide a second image that includes the additional data; and
receiving, by the processor, the second image of the one or more images that includes the additional data.

9. The method of claim 8, wherein providing the focusing request includes providing relative movements that the user may take to capture the second image.

10. The method of claim 1, wherein the processor utilizes a corpus of data to provide the response to the user.

11. A system comprising:
a processor; and
a memory in communication with the processor, the memory containing instructions that, when executed by the processor, cause the processor to:
receive a prompt from a user that includes a plurality of words;
determine, using natural language processing (NLP) techniques on the plurality of words, a request of the prompt;
receive one or more images from the user;
identify, from the one or more images, additional data related to the prompt; and
provide, to the user, a response to the request, the response determined in part with the additional data.

12. The system of claim 11, the memory further containing instructions that, when executed by the processor, cause the processor to determine that the additional data is needed to provide the response to the prompt.

13. The system of claim 12, the memory further containing instructions that, when executed by the processor, cause the processor to provide, in response to determining that the additional data is needed, a request to the user to provide the one or more images.

14. The system of claim 13, the memory further containing instructions that, when executed by the processor, cause the processor to determine that the user is having difficulty providing the additional data via the prompt, wherein providing the request is further in response to determining that the user is having the difficulty.

15. The system of claim 11, wherein the one or more images include a video stream of images of a camera integrated into an augmented reality wearable device of the user.

16. The system of claim 11, the memory further containing instructions for receiving the one or more images that, when executed by the processor, cause the processor to:
determine that a first image of the one or more images does not include the additional data;
provide, in response to determining that the first image does not include the additional data, a focusing request to the user to provide a second image that includes the additional data; and
receive the second image of the one or more images that includes the additional data.

17. The system of claim 16, wherein providing the focusing request includes providing relative navigation motions that the user may take to capture the second image.

18. A computer program product, the computer program product comprising a computer readable storage medium having program instructions embodied therewith, the program instructions executable by a computer to cause the computer to:
receive a prompt from a user that includes a plurality of words;
determine, using natural language processing (NLP) techniques on the plurality of words, a request of the prompt;
receive one or more images from the user;
identify, from the one or more images, additional data related to the prompt; and
provide, to the user, a response to the request, the response determined in part with the additional data.

19. The computer program product of claim 18, the computer readable storage medium containing further containing program instructions that, when executed by the computer, cause the computer to:
determine that the additional data is needed to provide the response to the prompt;
determine that the user is having difficulty providing the additional data via the prompt; and
provide, in response to both determining that the additional data is needed and determining that the user is having the difficulty, a request to the user to provide the one or more images.

20. The computer program product of claim 18, the computer readable storage medium containing further containing program instructions for receiving the one or more images that, when executed by the computer, cause the computer to:
determine that a first image of the one or more images does not include the additional data;
provide, in response to determining that the first image does not include the additional data, a focusing request to the user to provide a second image that includes the additional data; and
receive the second image of the one or more images that includes the additional data.
